(19) United States
(12) Patent Application Publication
(10) Pub. No.: US 2019/0098848 A1
(43) Pub. Date: Apr. 4, 2019

(54) AUTOMATED AEROPONIC GARDEN

(71) Applicant: Q Innovation, Tucson, AZ (US)

(72) Inventor: Fei Qin, Tucson, AZ (US)

(73) Assignee: Q Innovations, Tucson, AZ (US)

(21) Appl. No.: 15/937,841

(22) Filed: Mar. 27, 2018

Related U.S. Application Data
(60) Provisional application No. 62/477,016, filed on Mar. 27, 2017.

(51) Int. Cl. A01G 31/02; A01G 7/04; A01G 9/20; A01G 9/24; A01G 9/26; A01G 27/00; A01G 29/00

(52) U.S. Cl. CPC A01G 31/02; A01G 7/045; A01G 9/20; A01G 29/00; A01G 9/26; A01G 27/003; A01G 27/008; A01G 9/247

(57) ABSTRACT

System and apparatus for growing plants in an air and mist environment includes a growth unit and a power supply and support unit. The growth unit further includes an enclosure, a light source, a plant support that holds a plant, and a sprayer that sprays water and nutrients onto the plant. The power supply and support unit further includes a power converter that converts alternating current to direct current, a pump, and a processor configured to activate and deactivate the pump, and activate and deactivate the light source of the growth unit. The growth unit is connected to the power supply and support unit via a tube and a wire.

### CROSS-REFERENCES TO RELATED APPLICATIONS

This application claims the benefit of U.S. Provisional Patent Application No. 62/477,016, filed Mar. 27, 2017, entitled “PLANT BULB SURPRISE,” the entire disclosure of which is hereby incorporated by reference for all purposes.

### BACKGROUND

### 1. The Field of the Invention

The present invention generally relates to plant growing pods. More specifically, the present invention relates to aeroponic pod for growing plants that automatically performs watering, feeding and lighting adjustments.

### 2. The Relevant Technology

Plant pods have containers that hold plant nutrients in liquified form and a plant is suspended over the container so that the roots sit in the liquified nutrients. The plant is grown using hydroponics so that soil is not needed to reduce waste and mess. Light emitting diodes (LEDs) provide light for photosynthesis resulting in rapid, natural growth and abundant harvests. A control panel tells you when to add water, reminds you when to add patented nutrients and automatically turns the lights on and off.

### BRIEF SUMMARY

In one embodiment, a system for growing plants in an air and mist environment includes a growth unit and a power supply and support unit. The growth unit further includes an enclosure, a light source, a plant support that holds a plant, and a sprayer that sprays water and nutrients onto the plant. The power supply and support unit further includes a power converter that converts alternating current to direct current, a pump, and a processor configured to activate and deactivate the pump, and activate and deactivate the light source of the growth unit. The growth unit is connected to the power supply and support unit via a tube and a wire.

In another embodiment, an apparatus for growing plants in an air and mist environment includes a growth unit and a power supply and support unit. The growth unit further includes an enclosure, a light source, a plant support that holds a plant, and a sprayer that sprays water and nutrients onto the plant. The power supply and support unit further includes a power converter that converts alternating current to direct current, a pump, and a processor configured to activate and deactivate the pump, and activate and deactivate the light source of the growth unit. The growth unit is connected to the power supply and support unit via a tube and a wire.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a cutaway diagram of one embodiment of a system for growing plants in an air and mist environment.

FIG. 2 is a cutaway diagram of another embodiment of a system for growing plants in an air and mist environment.

FIG. 3 is a cutaway diagram of different embodiment of a system for growing plants in an air and mist environment.

FIG. 4 is a block diagram of an embodiment of a power supply and support unit for growing plants in an air and mist environment.

FIG. 5 is a cutaway diagram of an embodiment of a tube connection 500 for enabling the attachment of multiple growing units to a single power supply and support unit.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Plant growing pods use containers that hold water and nutrients to feed plants that are suspended above the container. This makes the pods bulky and heavy and restricts the placement of the pods to wide open spaces that have proper support. Furthermore, the plant growing pods require sufficient clearance above the space to allow the light to be extended as the plants grow.

The embodiments of the invention described herein below overcome the disadvantages of the prior art by providing systems and apparatuses that grow plants in an air and mist environment. Instead of suspending the plants over a container of water, nutrients and water are pumped through a nozzle and sprayed onto the roots. This enables the container of nutrients and water to be placed separate from the growing pod that holds the plants. Thus, the pods are lightweight and small and can be hung from the ceiling.

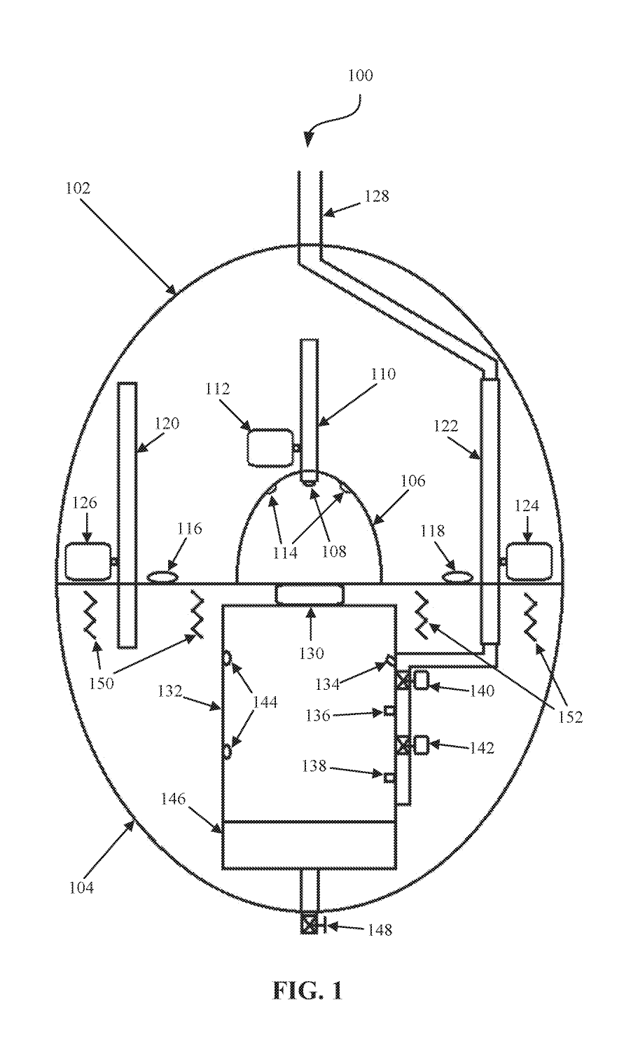

FIG. 1 is an example of a growing unit 100 that grows plants in an air and mist environment. Growing unit 100 includes an enclosure that comprises a top component 102 and a bottom component 104. The top component 102 of the enclosure includes a paraboloid shaped structure 106 that houses a light source 108. The paraboloid shaped structure 106 is at least semi reflective so that light from light source 108 is focused onto the plant. Light source 108 is attached to a support bar 110 can be adjusted to raise and lower light source 108. Motor 112 is used to adjust the position of support bar 110 telescopically, which can be a stepper motor, an actuator or a regular motor operated by pre-calculated timing. Paraboloid shaped structure 106 also includes one or more image sensors 114. Image sensors 114 are used to take pictures of the plant growing area and determine whether the plant has sprouted as well as the height of the plant using image processing techniques.

Top component 102 of the enclosure also houses one or more light sources 116 and image sensors 118 positioned at the bottom surface of top component 102. There can be any number of light sources 116 and image sensors 118 positioned in a radial geometry to provide light for the plant and capture images of the plant. The images can be transferred wirelessly to a server for image analysis to determine the size of the plant, coloring of the plant and other features of the plant. This can produce recommendations for adjusting the amount of different nutrients and water that is sprayed onto the roots of the plant. The recommendations can be transmitted to a mobile device or email address that has been added to an account that the growing pod is registered under.

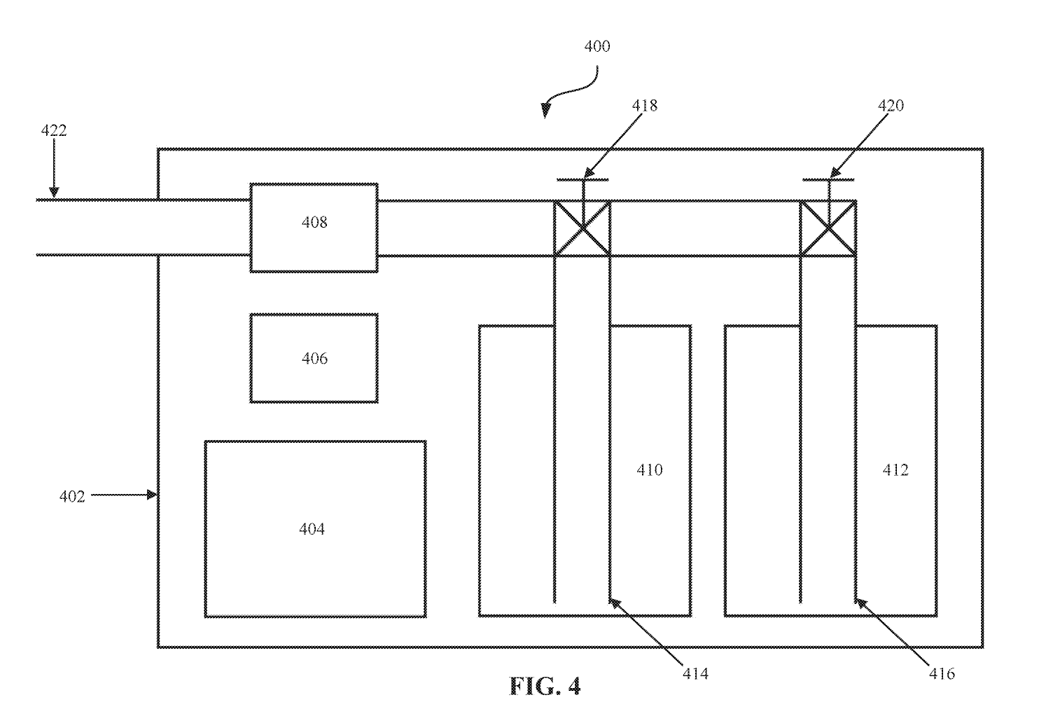

Top component 102 also includes support rods 120 and 122, which are operated by motors 124 and 126. Motors 124 and 126 can spin support rods 120 and 122 telescopically to automatically adjust the distance between top component 102 and bottom component 104 based on the size of the plant determined from image processing. Furthermore, support rod 120 or 122 can be used to run a tube 128 through the middle to hide tube 128 from view when top component 102 and bottom component 104 are separated. Tube 128 runs out of the tip of top component 102 so that the pod can be hung by tube 128 and tube 128 provides water, nutrients and power from a power supply and support unit shown in FIG. 4.

Bottom component 104 houses plant support 130 which can hold peat or a sponge that contains a seed. Bottom component 104 also houses a cavity 132 for the roots to expand and grow. Cavity 132 has nozzles 134, 136 and 138 positioned along a side wall for spraying water and nutrients onto the roots. Nozzles 134, 136 and 138 can be misting or atomizing nozzles. Actuator control valves 140 and 142 can be activated to direct water and nutrients to one or more of nozzles 134, 136 and 138. When actuator control valve 140 is in a closed position, water and nutrients are directed to nozzle 134. By opening actuator control valve 140 and when actuator control valve 142 is in a closed position, water and nutrients are directed to nozzles 134 and 136. By opening actuator control valve 140 and 142, water and nutrients are directed to all nozzles 134, 136 and 138. Cavity 132 also has one or more image sensors 144 attached to a side wall, which can be used to detect the size of the roots to automatically control actuator control valves 140 and 142. Another compartment 146 is positioned below cavity 132 to hold excess water and nutrients that can drip off the roots. Although not shown in the diagram, it is understood that there are holes cut out in the layer separating cavity 132 and compartment 146 that are dimensioned to allow water to pass through while stopping roots from growing in compartment 146. Furthermore, a sprout 148 is attached to the base of bottom component 104 to allow easy draining of compartment 146. Bottom component 104 also includes heating elements 150 and 152 to control the temperature inside grow pod 100.

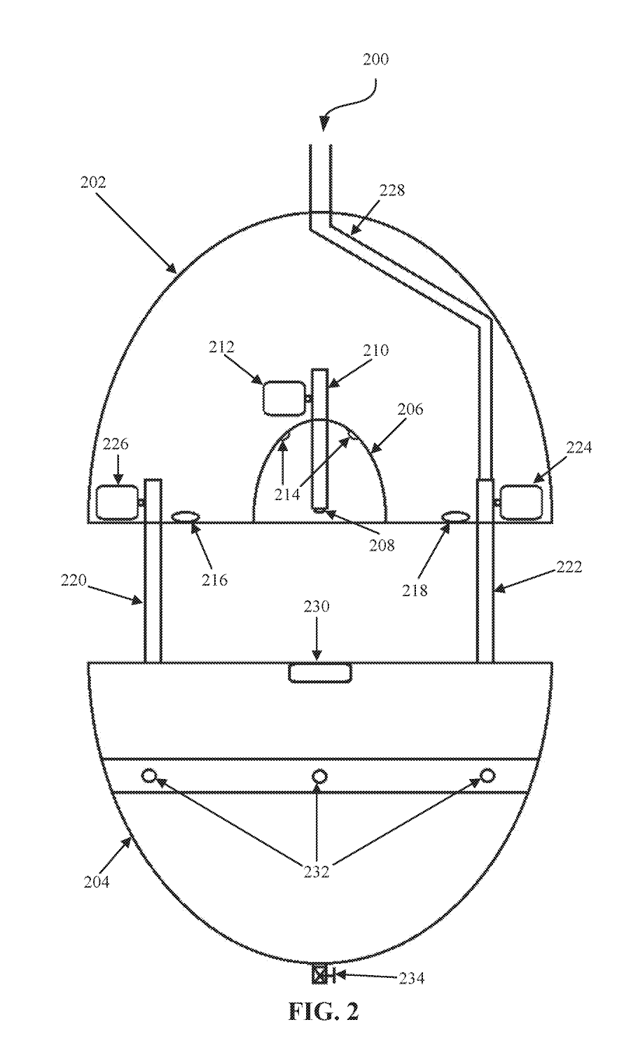

FIG. 2 is a cutaway diagram of another embodiment of a system 200 for growing plants in an air and mist environment. System 200 includes a top component 202 and a bottom component 204 that are shown separated in this figure. Top component 202 includes a paraboloid structure 206 that houses a light source 208 attached to a support rod 210 as well as one or more image sensors 214. In this figure, support rod 210 has been adjusted down to a lower position by operation of motor 212, which can be a stepper motor, an actuator or a regular motor operated by pre-calculated timing, based on images captured by image sensors 214. Top component 202 also includes one or image sensors 216 and one or more light sources 218, which are positioned in a radial geometry on the bottom surface of top component 202. Furthermore, in this figure, support rods 220 and 222 have been adjusted by motors 224 and 226 respectively to separate top component 202 from bottom component 204 based on images captured by one or more of image sensors 214 and 216. Tube 228 runs through the middles of support rod 222 to bottom component 204 to provide water and nutrients to the roots of the plant.

Most of the interior parts of bottom component 204 are not shown for the sake of clarity, except for plant holder 230. On the exterior of bottom component 204, a strip of light sources and image sensors 232 is positioned radially. Although the light sources and image sensors 232 are not numbered distinctly for the sake of clarity, it is understood that the light sources and image sensors 232 can be arranged in an alternative fashion or any other arrangement. A drain sprout 234 is also located at the base of bottom component 204 for draining excess water and nutrients that drip off the roots.

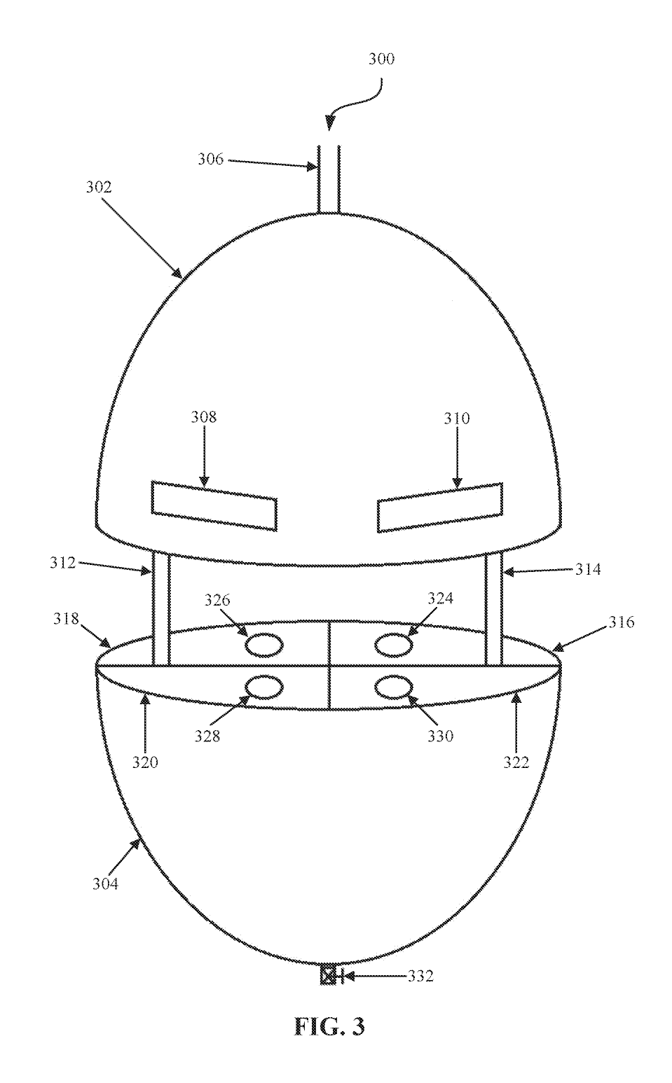

FIG. 3 is a cutaway diagram of different embodiment of a system 300 for growing plants in an air and mist environment. System 300 includes a top component 302 and a bottom component 304 that are extended away from each other, as well as tube 306 to provide water, nutrients and power from a power supply and support unit. Top component 302 also includes digital displays 308 and 310 for showing the species of plant and other relevant information. Although only two digital displays 308 and 310 are shown in this figure, it is understood that any number of displays can be included on either top component 302 or bottom component 304, corresponding to the number of plants that there are spaces for, of which there are four in this figure.

Bottom component 304 is supported from top component 302 by support rods 312. In this figure, there are four spaces 316, 318, 320 and 322, each with a plant support 324, 326, 328 and 330. Although only four spaces are shown in this figure for growing four different plants, it is understood that there can be any number of spaces. Drain sprout 332 is placed at the base of bottom component 304 to remove excess water and nutrients that drip off.

FIG. 4 is a block diagram of an embodiment of a power supply and support unit 400 for growing plants in an air and mist environment, which includes an enclosure 402. Enclosure 402 houses an alternating current to direct current (AC/DC) converter 404, a computer processor 406, a pump 408, storage tanks 410 and 412 each with pipes 414 and 416 inserted respectively, and actuator control valves 418 and 420. Although only two storage tanks 410 and 412 are shown in this figure, it is understood that there can be any number of tanks for holding water and different nutrients, each with an actuator control valve attached to the inserted pipe. Actuator control valves 418 and 420 are activated by computer processor 406 to provide different mixtures of water and nutrients depending on the plant type, size, climate and other factors. Pump 408 is also activated by computer processor 406 to pump water and nutrients out of tube 422, which goes to one or more growth pods. Although not shown in this figure, power supply and support unit 400 can also include a wireless chip for transferring data wirelessly to and from a computer for image processing and retrieving water nutrient mixture values.

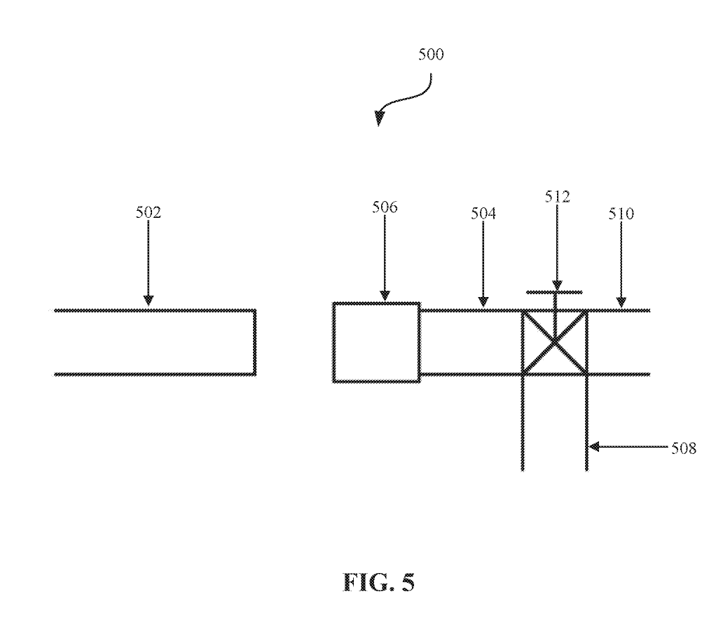

FIG. 5 is a cutaway diagram of an embodiment of a tube connection 500 for enabling the attachment of multiple growing units to a single power supply and support unit. The male ended tube 502 goes to a second growing unit and the female ended tube 504 has a receiver 506 that the male end of tube 502 is inserted into. Bottom end 508 of tube 504 goes to a first growing unit and right end 510 of tube 504 goes to the power supply and support unit. Actuator control valve 512 is used to control the flow of water and nutrients to either the first growing unit or the second growing unit. The female end of tube 502 has the same setup as the female end of tube 504 to allow additional growing units to be attached. The number of growing units can be configured using a mobile device and can be stored under a user account on a computer server. The tubes 502 and 504 can be wrapped in electricity conducting wires to also provide power and control signals, which can be in series or in parallel, from the power supply and control unit to the growing units. The control signals can be sent to a computer processor on each growing unit which can be further used to activate the motors and actuator control valves in each growing unit.

While the principles of the disclosure have been described above in connection with specific apparatuses and methods, it is to be clearly understood that this description is made only by way of example and not as limitation on the scope of the disclosure.

1. A system for growing plants in an air and mist environment, the system comprising:
a growth unit comprising:
an enclosure,
a light source,
a plant support that holds a plant, and
a sprayer that sprays water and nutrients onto the plant; and
a power supply and support unit comprising:
a power converter that converts alternating current to direct current,
a pump, and
a processor configured to:
activate and deactivate the pump, and
activate and deactivate the light source of the growth unit;
wherein the growth unit is connected to the power supply and support unit via a tube and a wire.

2. The system of claim 1, wherein the enclosure of the growth unit further comprises:
a first component that houses the light source; and
a second component that houses the plant support and the sprayer,
wherein the distance between the first component and the second component is adjustable.

3. The system of claim 2, wherein the growth unit further comprises a sensor that detects the height of the plant, and wherein the processor is further configured to adjust the distance between the first component and the second component of the enclosure based on the detected height of the plant.

4. The system of claim 3, wherein the sensor comprises at least one of a camera, an infrared sensor, and an ultrasonic sensor.

5. The system of claim 3, wherein the growth unit further comprises a step motor, and wherein the processor is configured to adjust the distance between the first component and the second component of the enclosure utilizing the step motor.

6. The system of claim 3, wherein a position of the light source is adjustable within the first component of the growth unit.

7. The system of claim 6, wherein the processor is further configured to adjust the position of the light source based on the detected height of the plant.

8. The system of claim 1, wherein the sprayer comprises at least one of an air atomizer and a hydraulic atomizer.

9. The system of claim 1, wherein the plant support is dimensioned to hold a peat that contains a seed.

10. The system of claim 1, wherein the light source is contained within a paraboloid shaped structure that is at least semi reflective.

11. An apparatus for growing plants in an air and mist environment, the apparatus comprising:
a growth unit comprising:
an enclosure,
a first light source,
a plant support that holds a plant, and
a sprayer that sprays water and nutrients onto the plant; and
a power supply and support unit comprising:
a power converter that converts alternating current to direct current,
a pump, and
a processor configured to:
activate and deactivate the pump, and
activate and deactivate the first light source of the growth unit;
wherein the growth unit is connected to the power supply and support unit via a tube and a wire.

12. The apparatus of claim 11, wherein the enclosure of the growth unit further comprises:
a first component that houses the first light source;
a second component that houses the plant support and the sprayer; and
a second light source positioned on an outside surface of the second component of the enclosure of the growth unit.

13. The apparatus of claim 12, wherein a light direction of the second light source is adjustable.

14. The apparatus of claim 13, further comprising an actuator connected to the second light source, wherein the processor is further configured to activate the actuator.

15. The apparatus of claim 14, further comprising a sensor positioned on the outside surface of the second component of the enclosure of the growth unit for detecting the plant, wherein the processor activates the actuator based on data from the sensor.

16. The apparatus of claim 15, wherein the processor is further configured to activate the second light source based on data from the sensor.

17. The apparatus of claim 11, further comprising an image sensor, wherein the processor is further configured to transmit data from the image sensor wirelessly to a computer server.

18. The apparatus of claim 17, wherein the processor is configured to activate the pump for a predetermined amount of time before deactivating the pump based on data received from the computer server.

19. The apparatus of claim 11, further comprising a digital display.

20. The apparatus of claim 19, wherein the processor is further configured to display information on the digital display based on data received from a mobile device.
